(19) United States
(12) Patent Application Publication
(10) Pub. No.: US 2025/0028763 A1
(43) Pub. Date: Jan. 23, 2025

(54) STORING VITAL DOCUMENTS

(71) Applicant: GovPlus LLC, San Juan, PR (US)

(72) Inventor: Guy LELOUCH, San Juan, PR (US)

(21) Appl. No.: 18/673,137

(22) Filed: May 23, 2024

Related U.S. Application Data
(63) Continuation of application No. 17/807,285, filed on Jun. 16, 2022.
(60) Provisional application No. 63/217,407, filed on Jul. 1, 2021.
(60) Provisional application No. 63/213,561, filed on Jun. 22, 2021.

(51) Int. Cl. G06F 16/93; G06F 21/31; G06F 21/60; G06F 21/62; G06Q 50/00

(52) U.S. Cl. CPC G06F 16/93; G06F 21/31; G06F 21/606; G06F 21/6245; G06F 2221/2117; G06F 2221/2137; G06Q 50/00

(57) ABSTRACT

Methods, storage media, and systems for storing a vital document are disclosed. Some embodiments may include: logging, by a user, into an account, checking, by a processor, if the account contains at least one vital document, if the user had not uploaded the at least one vital document, prompting the user, by the processor, to upload the at least one vital document, displaying, on a display of a computer, the at least one vital document in a view-only mode and sharing the at least one vital document via email to a third-party recipient or via download to a local device using a one-time, password-encrypted, time-limited link.

### CROSS-REFERENCE

This application claims the benefit of the filing date as a continuation of the U.S. patent application Ser. No. 17/807,285, filed on Jun. 16, 2022, now allowed, claims the benefit of priority of the U.S. Provisional Patent Application Ser. No. 63/213,561 filed Jun. 22, 2021, and also claims the benefit of priority of the U.S. Provisional Patent Application Ser. No. 63/217,407 filed Jul. 1, 2021, the disclosures of which are each incorporated by reference in their entireties for all purposes.

### FIELD OF THE DISCLOSURE

The present disclosure relates to methods, storage media, and systems for storing a vital document.

### BACKGROUND

These days we have a huge amount of valuable documents from different places. We need to keep the birth certificates, passports, ID cards, Social Security cards, Employee Identification Numbers, and other vital documents in one place. It is hard to keep everything structured and avoid missing something, resulting in losing some documents and taking much time to renew them.

Also, in many cases, these documents must be produced immediately upon request from local entities for document-related procedures. Such situations take extra time—from 1 day to several weeks—which can be better spent on other life activities. It is time-consuming to obtain the initial document, scan or photograph it, reformat to a digital format applicable for better viewing, and provide it to the entity which requested it. Many users complain about not having all of the necessary documents in one place, available to be viewed and shared from any device anywhere. The present disclosure assists them with our proprietary software solution.

### SUMMARY

The following embodiments and aspects are described and illustrated in conjunction with methods, media, and systems, which are meant to be exemplary and illustrative, not limiting in scope. In various embodiments, one or more of the above-described problems have been reduced or eliminated, while other embodiments are directed to other improvements.

The present disclosure provides a computerized method for storing a vital document. The method may include logging, by a user, into an account. The method may include checking, by a processor, if the account contains at least one vital document previously uploaded by the user. The method may include if the user had not uploaded the at least one vital document, prompting the user, by the processor, to upload the at least one vital document or to apply for the at least one vital document. The method may include displaying, on a display of a computer, the at least one vital document in a view-only mode. The method may include sharing the at least one vital document via email to a third-party recipient or via download to a local device using a one-time, password-encrypted, time-limited link.

The present disclosure also provides a non-transient computer-readable storage medium for storing a vital document. In some embodiments, the computer-readable storage medium may include instructions being executable by one or more processors to log, by a user, into an account. In some embodiments, the computer-readable storage medium may include instructions being executable by one or more processors to check, by the one or more processors, if the account contains at least one vital document previously uploaded by the user. In some embodiments, the computer-readable storage medium may include instructions being executable by one or more processors to if the user had not uploaded the at least one vital document, prompt the user, by the one or more processors, to upload the at least one vital document or to apply for the at least one vital document. In some embodiments, the computer-readable storage medium may include instructions being executable by one or more processors to display, on a display of a computer, the at least one vital document in a view-only mode. In some embodiments, the computer-readable storage medium may include instructions being executable by one or more processors to share the at least one vital document via email using a one-time, password-encrypted, time-limited link or via download to a local device to a third-party recipient.

The present disclosure further provides a system for storing a vital document. The system may include one or more hardware processors configured by machine-readable instructions for storing a vital document. The machine-readable instructions may be configured to log, by a user, into an account. The machine-readable instructions may be configured to check, by the one or more hardware processors, if the account contains at least one vital document previously uploaded by the user. The machine-readable instructions may be configured to if the user had not uploaded the at least one vital document, prompt the user, by the one or more hardware processors, to upload the at least one vital document or to apply for the at least one vital document. The machine-readable instructions may be configured to display, on a display of a computer, the at least one vital document in a view-only mode. The machine-readable instructions may be configured to share the at least one vital document via email to a third-party recipient using a one-time, password-encrypted, time-limited link or via download to a local device.

Additional embodiments and features are set forth in part in the description that follows. In part will become apparent to those skilled in the art upon examination of the specification or learned by the practice of the embodiments discussed herein. A further understanding of the nature and advantages of certain embodiments may be realized by reference to the remaining portions of the specification and the drawings, which form a part of this disclosure.

### BRIEF DESCRIPTION OF THE DRAWINGS

The disclosure will be readily understood by the following detailed description in conjunction with the accompanying drawings, wherein like reference numerals designate like structural elements. The drawings provide exemplary embodiments or aspects of the disclosure and do not limit the scope of the disclosure.

FIG. 1 illustrates a system configured for storing a vital document.

FIG. 2 illustrates a method for storing a vital document.

FIG. 3 is a flowchart showing the steps of an embodiment of the disclosed method for storing a vital document.

FIG. 4 is a block diagram illustrating an example of a suitable computing system environment in which aspects of the present disclosure may be implemented.

### DETAILED DESCRIPTION

The present disclosure provides a proprietary cloud-based software solution, which allows the users to store the valuable documents needed for their living. The user can store either their vital documents (ID card, Birth certificate, Social Security Card) or the personal ones (driving license, insurance card, Employee Identification Number, medical card, individual taxpayer, Limited Liability Company (LLC), Limited Liability Partnership (LLP), and corporate documents, etc.) in secure cloud storage.

The accounts and secure cloud storage use up-to-date encryption standards. In certain embodiments, two-factor authentication (2FA) may be used for data security. Suitable examples of 2FA include, but are not limited to, passwords, one-time codes sent to another device, biometrics (fingerprint, rental scan, voice signature), JKS key, or digital token. Documents protected via encryption are unavailable without the user's direct permission.

In certain embodiments, the encryption algorithm for encrypted cloud storage is proprietary. Additionally, in certain embodiments, data encryption is maintained throughout the method.

In certain embodiments, applying for vital documents requires verification of other vital documents. For example, applying for a passport may require a birth certificate and/or driver's license verification. In such embodiments, the vital document may be an image file or a certified electronic copy from the issuing government authority, such as a birth certificate, driver's license, or passport. In certain embodiments, the vital document is saved in the encrypted cloud drive for the user to use later, for example, to verify the user's identity, to verify the user's signature, or to submit as supporting documentation for a government application.

In certain embodiments, the method further comprises applying for the at least one vital document.

In certain embodiments, the method further comprises determining whether the account exists, and wherein if the account exists, the processor processes the login further.

In certain embodiments, if the account does not exist, the processor proposes to the user to create a new account.

In certain embodiments, the at least one vital document is available on a Personal Account Dashboard. In certain embodiments, the user's personal information is available on a Personal Account Dashboard.

All documents can be easily accessed from any device and location, such as cross-platform Web portal, iOS, Android, Tablet clients, and dedicated desktop applications. Furthermore, the documents can be shared securely via emailing the one-time secure link to a third-party recipient or downloaded directly to a local device.

In certain embodiments, the user is verified, for example, using a vital document. In certain embodiments, the user's signature is verified, for example, using a vital document or a third-party signature service, such as DocuSign, Dotloop, or Adobe, or electronic token exchange, such as using a public or private key.

“New data” refers to a distinct category or field that is different from any category or field data that was previously captured. In certain embodiments, the categories or field data are detected based on machine-readable data.

Without wishing to be bound by theory, not having to refill form data that has previously been captured increases the efficiency of use for a general-purpose computer. The data remain encrypted between forms and do not need to be copied into the clipboard function of the general-purpose computer.

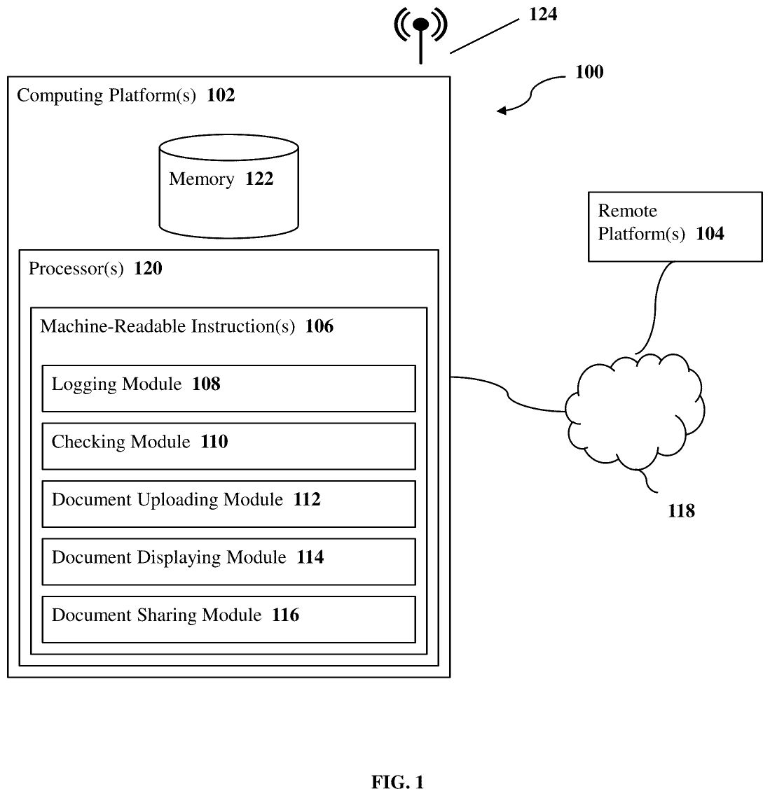

FIG. 1 illustrates a system configured for storing a vital document per one or more embodiments. In some cases, system 100 may include one or more computing platforms 102. The one or more remote computing platforms 102 may be communicably coupled with one or more remote platforms 104. Users may sometimes access the system 100 via remote platform(s) 104.

The one or more computing platforms 102 may be configured by machine-readable instructions 106. Machine-readable instructions 106 may include modules. The modules may be implemented as one or more of functional logic, hardware logic, electronic circuitry, software modules, and the like. For example, the modules may include one or more of logging module 108, checking module 110, document uploading module 112, document displaying module 114, document sharing module 116, and/or other modules.

Logging module 108 may be configured to log, by the user, into an account. Checking module 110 may be configured to check, by the processor, if the account contains at least one vital document. Document uploading module 112 may be configured to if the user had not uploaded the at least one vital document, prompt the user, by the processor, to upload the at least one vital document or to apply for the at least one vital document. Document displaying module 114 may be configured to display, on a display of a computer, the at least one vital document in a view-only mode. Document sharing module 116 may be configured to share the at least one vital document via email to a third-party recipient or download to a local device using a one-time, password-encrypted, time-limited link.

In some cases, the one or more computing platforms 102 may be communicatively coupled to the remote platform(s) 104. In some cases, the communicative coupling may include communicative coupling through a networked environment 118. The networked environment 118 may be a radio access network, such as LTE or 5G, a local area network (LAN), a wide area network (WAN) such as the Internet, or wireless LAN (WLAN), for example. It will be appreciated that this is not intended to be limiting and that the scope of this disclosure includes implementations in which one or more computing platforms 102 and remote platform(s) 104 may be operatively linked via some other communication coupling. For example, one or more computing platforms 102 may be configured to communicate with the networked environment 118 via wireless or wired connections. In addition, in an embodiment, one or more computing platforms 102 may be configured to communicate directly with each other via wireless or wired connections. Examples of one or more computing platforms 102 may include, but is not limited to, smartphones, wearable devices, tablets, laptop computers, desktop computers, Internet of Things (IoT) device, or other mobile or stationary devices. In an embodiment, system 100 may also include one or more hosts or servers, such as the one or more remote platforms 104 connected to the networked environment 118 through wireless or wired connections. According to one embodiment, remote platforms 104 may be implemented in or function as base stations (which may also be referred to as Node Bs or evolved Node Bs (eNBs)). In other embodiments, remote platforms 104 may include web servers, mail servers, application servers, etc. According to certain embodiments, remote platforms 104 may be standalone servers, networked servers, or an array of servers.

The one or more computing platforms 102 may include one or more processors 120 for processing information and executing instructions or operations. One or more processors 120 may be any general or specific purpose processor. In some cases, multiple processors 120 may be used according to other embodiments. For example, the one or more processors 120 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In addition, in some cases, the one or more processors 120 may be remote from the one or more computing platforms 102, such as disposed within a remote platform like the one or more remote platforms 120 of FIG. 1.

The one or more processors 120 may perform functions for the operation of system 100, which may include, for example, precoding of antenna gain/phase parameters, encoding, and decoding of individual bits forming a communication message, formatting of information, and overall control of the one or more computing platforms 102, including processes related to managing communication resources.

The one or more computing platforms 102 may further include or be coupled to a memory 122 (internal or external), which may be coupled to one or more processors 120, for storing information and instructions that may be executed by one or more processors 120. Memory 122 may be one or more memories and of any type suitable to the local application environment and may be implemented using any suitable volatile or nonvolatile data storage technology such as a semiconductor-based memory device, a magnetic memory device and system, an optical memory device, and system, fixed memory, and removable memory. For example, memory 122 can consist of any combination of random access memory (RAM), read-only memory (ROM), static storage such as a magnetic or optical disk, hard disk drive (HDD), or any other type of non-transitory machine or computer-readable media. The instructions stored in memory 122 may include program instructions or computer program code that, when executed by one or more processors 120, enable the one or more computing platforms 102 to perform tasks described herein.

In some embodiments, one or more computing platforms 102 may also include or be coupled to one or more antennas for transmitting and receiving signals and/or data to and from one or more computing platforms 102. The one or more antennas may be configured to communicate via, for example, a plurality of radio interfaces that may be coupled to one or more antennas. The radio interfaces may correspond to a plurality of radio access technologies, including one or more of LTE, 5G, WLAN, Bluetooth, near field communication (NFC), radio frequency identifier (RFID), ultra wideband (UWB), and the like. In addition, the radio interface may include components, such as filters, converters (for example, digital-to-analog converters and the like), mappers, a Fast Fourier Transform (FFT) module, and the like, to generate symbols for transmission via one or more downlinks and to receive symbols (for example, via an uplink).

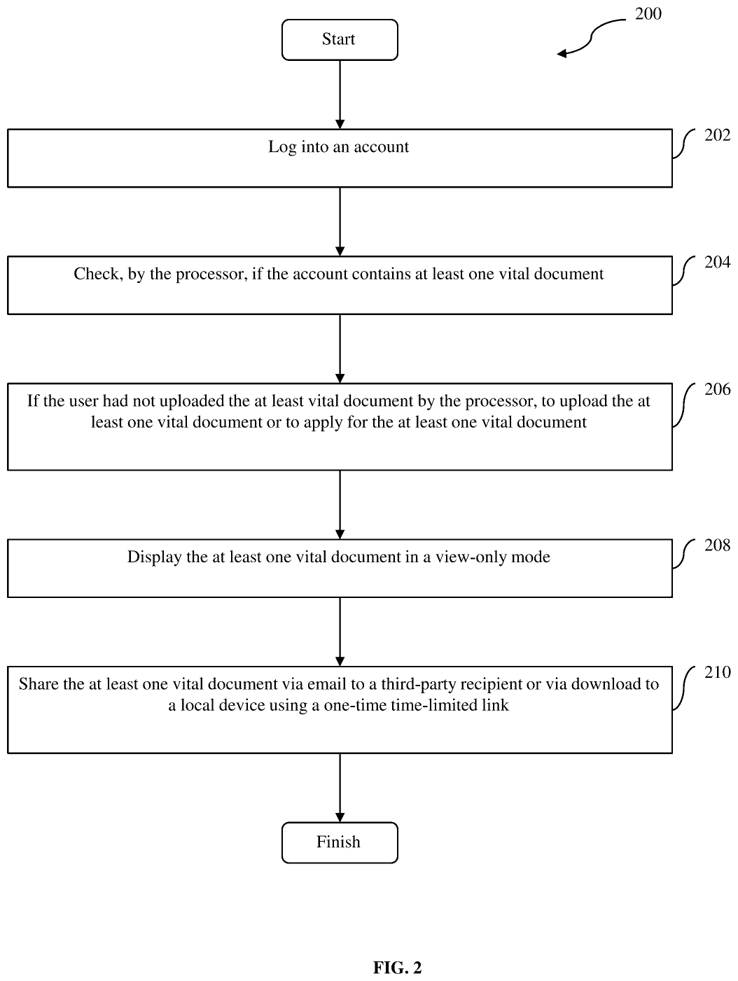

FIG. 2 illustrates an example flow diagram of a method 200, according to one embodiment. Method 200 may include logging, by the user, into an account at block 202. Method 200 may include checking, by the processor, if the account contains at least one vital document at block 204. Method 200 may include if the user had not uploaded the at least one vital document, prompting the user, by the processor, to upload the at least one vital document or to apply for the at least one vital document at block 206. Method 200 may include displaying, on a display of a computer, the at least one vital document in a view-only mode at block 208. Method 200 may include sharing the at least one vital document via email to a third-party recipient or via download to a local device using a one-time, password-encrypted, time-limited link at block 210.

In some cases, method 200 may be performed by one or more hardware processors, such as the processors 120 of FIG. 1, configured by machine-readable instructions, such as the machine-readable instructions 106 of FIG. 1. In this aspect, method 200 may be configured to be implemented by the modules, such as the modules 108, 110, 112, 114, and/or 116 discussed above in FIG. 1.

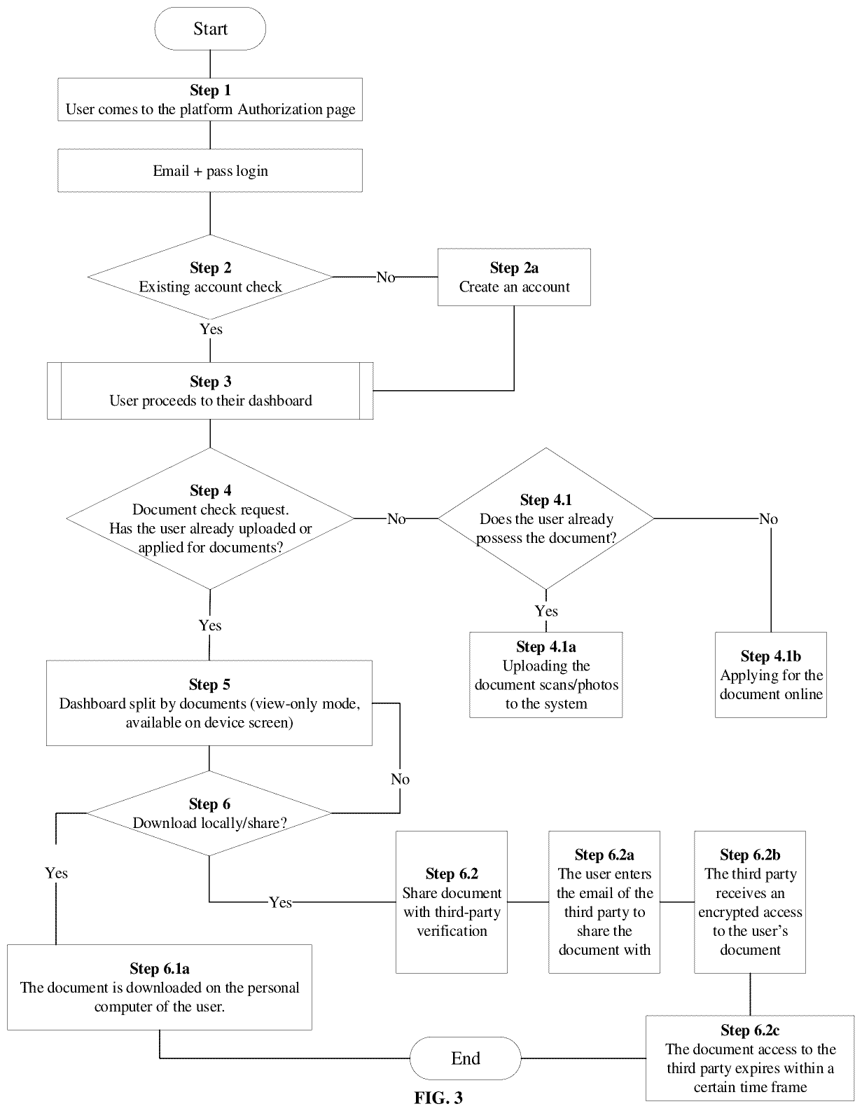

FIG. 3 is a flowchart showing the steps of an embodiment of the disclosed method for storing a vital document.

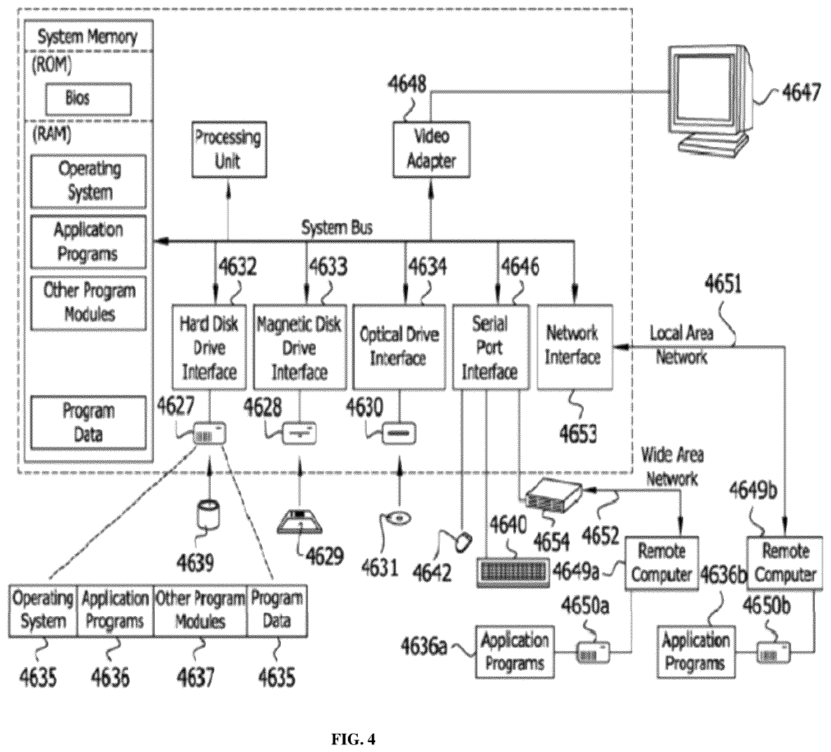

With reference to FIG. 4, an exemplary system for implementing aspects of the disclosure includes a general-purpose computing device in the form of a conventional computer 4620, including a processing unit 4621, a system memory 4622, and a system bus 4623 that couples various system components, including the system memory 4622 to the processing unit 4621. The system bus 4623 may be any of several bus structures, including a memory bus or memory controller, a peripheral bus, and a local bus using various bus architectures. The system memory includes read-only memory (ROM) 4624 and random-access memory (RAM) 4625. A basic input/output system (BIOS) 4626, containing the basic routines that help transfer information between elements within the computer 4620, such as during start-up, may be stored in ROM 4624.

The computer 4620 may also include a magnetic hard disk drive 4627 for reading from and writing to a magnetic hard disk 4639, a magnetic disk drive 4628 for reading from or writing to a removable magnetic disk 4629, and an optical disk drive 4630 for reading from or writing to removable optical disk 4631, such as a CD-ROM or other optical media. The magnetic hard disk drive 4627, magnetic disk drive 4628, and optical disk drive 4630 are connected to the system bus 4623 by a hard disk drive interface 4632, a magnetic disk drive interface 4633, and an optical drive interface 4634, respectively. The drives and their associated computer-readable media provide nonvolatile storage of computer-executable instructions, data structures, program modules, and other data for the computer 4620. Although the exemplary environment described herein employs a magnetic hard disk 4639, a removable magnetic disk 4629, and a removable optical disk 4631, other types of computer-readable media for storing data can be used, including magnetic cassettes, flash memory cards, digital video disks, Bernoulli cartridges, RAMs, ROMs, and the like.

Program code means comprising one or more program modules may be stored on the hard disk 4639, magnetic disk 4629, optical disk 4631, ROM 4624, and/or RAM 4625, including an operating system 4635, one or more application programs 4636, other program modules 4637, and program data 4638. A user may enter commands and information into the computer 4620 through keyboard 4640, pointing device 4642, or other input devices (not shown), such as a microphone, joystick, gamepad, satellite dish, scanner, or the like. These and other input devices are often connected to the processing unit 4621 through a serial port interface 4646 coupled to the system bus 4623. Alternatively, the input devices may be connected by other interfaces, such as a parallel port, a game port, or a universal serial bus (USB). A monitor 4647 or another display device is also connected to system bus 4623 via an interface, such as video adapter 4648. In addition to the monitor, personal computers typically include other peripheral output devices (not shown), such as speakers and printers.

The computer 4620 may operate in a networked environment using logical connections to one or more remote computers, such as remote computers 4649a and 4649b. Remote computers 4649a and 4649b may each be another personal computer, a server, a router, a network PC, a peer device, or another common network node. These typically include many or all the above elements relative to the computer 4620. However, only memory storage devices 4650a and 4650b and their associated application programs 4636a and 4636b have been illustrated in FIG. 5. The logical connections depicted in FIG. 5 include a local area network (LAN) 4651 and a wide area network (WAN) 4652 presented here by way of example and not limitation. Such networking environments are commonplace in office-wide or enterprise-wide computer networks, intranets, and the Internet.

When used in a LAN networking environment, the computer 4620 is connected to the local network 4651 through a network interface or adapter 4653. When used in a WAN networking environment, the computer 4620 may include a modem 4654, a wireless link, or other means for establishing communications over the wide area network 4652, such as the Internet. The modem 4654, internal or external, is connected to the system bus 4623 via the serial port interface 4646. In a networked environment, program modules depicted relative to the computer 4620 or portions thereof may be stored in the remote memory storage device. It will be appreciated that the network connections shown are exemplary and other means of establishing communications over a wide area network 4652 may be used.

One or more aspects of the disclosure may be embodied in computer-executable instructions (i.e., software), such as a software object, routine, or function (collectively referred to herein as a software) stored in system memory 4624 or nonvolatile memory 4635 as application programs 4636, program modules 4637, and/or program data 4638. The software may alternatively be stored remotely, such as on remote computers 4649a and 4649b with remote application programs 4636b. Generally, program modules include routines, programs, objects, components, data structures, etc., that perform particular tasks or implement particular abstract data types when executed by a processor in a computer or other device. The computer-executable instructions may be stored on a computer-readable medium such as a hard disk 4627, optical disk 4630, solid-state memory, RAM 4625, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like.

A programming interface (or, more simply, interface) may be viewed as any mechanism, process, or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), function call(s), module(s), etc. of another component(s). The term “segment of code” in the preceding sentence is intended to include one or more instructions or lines of code. Thus, it includes, e.g., code modules, objects, subroutines, functions, and so on, regardless of the terminology applied or whether the code segments are separately compiled, or whether the code segments are provided as a source, intermediate, or object code, whether the code segments are used in a run-time system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming interface (API), entry point, method, function, subroutine, remote procedure call, and component object model (COM) interface are encompassed within the definition programming interface.

Aspects of such a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing, and content of the information. In this regard, the underlying transport medium itself may be unimportant to the operation of the interface, whether the medium is wired or wireless, or a combination of both, as long as the information is transported in the manner defined by the interface. In certain situations, information may not be passed in one or both directions in the conventional sense, as the information transfer may be either via another mechanism (e.g., information placed in a buffer, file, etc. separate from information flow between the code segments) or non-existent, as when one code segment accesses functionality performed by a second code segment. Any or all these aspects may be important in a given situation, e.g., depending on whether the code segments are part of a system in a loosely coupled or tightly coupled configuration. So this list should be considered illustrative and non-limiting.

This notion of a programming interface is known to those skilled in the art and is clear from the provided detailed description. Some illustrative implementations of a programming interface may also include factoring, redefinition, inline coding, divorce, and rewriting, to name a few. There are, however, other ways to implement a programming interface. Unless expressly excluded, these are intended to be encompassed by the claims set forth at the end of this specification.

In certain embodiments, the instructions further comprise applying for the at least one vital document.

In certain embodiments, the one or more hardware processors of the system are further confirmed by machine-readable instructions to determine whether an account exists, and wherein, if the account exists, the one or more hardware processors process the login further.

In certain embodiments, if the account does not exist, the system's one or more hardware processors propose to the user to create a new account.

Embodiments within the scope of the present disclosure also include computer-readable media and computer-readable storage media for carrying or having computer-executable instructions or data structures stored thereon. Such computer-readable media can be any available media accessed by a general or special purpose computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code means in the form of computer-executable instructions or data structures, and that can be accessed by a general-purpose or special-purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general-purpose computer, special purpose computer, or special purpose processing device to perform a certain function or group of functions.

When introducing elements of the present disclosure or the embodiments(s) thereof, the articles “a,” “an,” “the,” and “said” are intended to mean that there are one or more of the elements. The terms “comprising,” “including,” and “having” are intended to be inclusive and mean that there may be additional elements other than the listed elements.

### EP SUPPORT EXAMPLE

Example 1 includes a method comprising: logging, by a user, into an account, checking, by a processor, if the account contains at least one vital document, if the user had not uploaded the at least one vital document, prompting the user, by the processor, to upload the at least one vital document or to apply for the at least one vital document, displaying, on a display of a computer, the at least one vital document in a view-only mode and sharing the at least one vital document via email to a third-party recipient or via download to a local device using a one-time, password-encrypted, time-limited link.

Example 2 includes a storage medium comprising: logging, by a user, into an account, checking, by a processor, if the account contains at least one vital document, if the user had not uploaded the at least one vital document, prompting the user, by the processor, to upload the at least one vital document or to apply for the at least one vital document, displaying, on a display of a computer, the at least one vital document in a view-only mode and sharing the at least one vital document via email to a third-party recipient or via download to a local device using a one-time, password-encrypted, time-limited link.

Example 3 includes a system comprising: logging, by a user, into an account, checking, by a processor, if the account contains at least one vital document, if the user had not uploaded the at least one vital document, prompting the user, by the processor, to upload the at least one vital document or to apply for the at least one vital document, displaying, on a display of a computer, the at least one vital document in a view-only mode and sharing the at least one vital document via email to a third-party recipient or via download to a local device using a one-time, password-encrypted, time-limited link.

Although the subject matter has been described in language specific to structural features and/or methodological acts, it must be understood that the subject matter defined in the appended claims is not necessarily limited to the specific features or acts described above. Rather, the specific features and acts described above are disclosed as examples of implementing aspects of the present disclosure.

All references, patents, or applications, U.S. or foreign, cited in the application are because of this incorporated by reference as if written herein in their entireties. Where any inconsistencies arise, the material disclosed herein controls.

From the preceding description, one skilled in the art can easily ascertain the essential characteristics of this invention. Without departing from the spirit and scope thereof, various changes and modifications of the invention adapt it to various usages and conditions.

What is claimed is:

1. A computerized method for storing a vital document, the method comprising the steps of:
logging, by a user, into an account;
checking, by a processor, if the account contains at least one vital document previously uploaded by the user;
if the user had not uploaded the at least one vital document, prompting the user, by the processor, to upload the at least one vital document;
displaying, on a display of a computer, the at least one vital document in a view-only mode;
sharing the at least one vital document via email to a third-party recipient or via download to a local device using a one-time, password-encrypted, time-limited link; and
applying for at least one additional vital document chosen from a birth certificate, passport, and driver's license.

2. (canceled)

3. The method of claim 1 further comprising determining whether the account exists, and wherein if the account exists, the processor processes the login further.

4. The method of claim 3, wherein, if the account does not exist, the processor proposes to the user to create a new account.

5. The method of claim 1, wherein the at least one vital document is available on a Personal Account Dashboard.

6. A non-transient computer-readable storage medium comprising instructions being executable by one or more processors to perform a method for storing a vital document, the method comprising:
logging, by a user, into an account;
checking, by the one or more processors, if the account contains at least one vital document previously uploaded by the user;
if the user had not uploaded the at least one vital document, prompting the user, by the processor, to upload the at least one vital document;
displaying, on a display of a computer, the at least one vital document in a view-only mode;
sharing the at least one vital document via email to a third-party recipient or via download to a local device using a one-time, password-encrypted, time-limited link; and
applying for at least one additional vital document chosen from a birth certificate, passport, and driver's license.

7. (canceled)

8. The medium of claim 6, wherein the method further comprises determining if the account exists and wherein, if the account exists, the processor processes the login further.

9. The medium of claim 8, wherein, if the account does not exist, the processor proposes to the user to create a new account.

10. The medium of claim 6, wherein the at least one vital document is available on a Personal Account Dashboard.

11. A system comprising:
one or more hardware processors configured by machine-readable instructions to:
log, by a user, into an account;
check, by the one or more hardware processors, if the account contains at least one vital document previously uploaded by the user;
if the user had not uploaded the at least one vital document, prompt the user, by the one or more hardware processors, to upload the at least one vital document;
display, on a display of a computer, the at least one vital document in a view-only mode;
share the at least one vital document via email to a third-party recipient or via download to a local device using a one-time, password-encrypted, time-limited link; and
applying for at least one additional vital document chosen from a birth certificate, passport, and driver's license.

12. (canceled)

13. The system of claim 11, wherein the one or more hardware processors are further confirmed by machine-readable instructions to determine whether an account exists, and wherein, if the account exists, the one or more hardware processors process the login further.

14. The system of claim 11, wherein, if the account does not exist, the one or more hardware processors propose to the user to create a new account.

15. The system of claim 11, wherein the at least one vital document is available on a Personal Account Dashboard.

16. The system of claim 11, wherein the vital document is saved in an encrypted cloud drive for the user to use later to verify the user's identity, to verify the user's signature, or to submit as supporting documentation for a government application.

17. The method of claim 1, wherein the vital document is saved in an encrypted cloud drive for the user to use later to verify the user's identity, to verify the user's signature, or to submit as supporting documentation for a government application.

18. The medium of claim 6, wherein the vital document is saved in an encrypted cloud drive for the user to use later to verify the user's identity, to verify the user's signature, or to submit as supporting documentation for a government application.
